(19) United States
(12) Patent Application Publication
(10) Pub. No.: US 2024/0056361 A1
(43) Pub. Date: Feb. 15, 2024

(54) EVENT INJECTION FOR ANALYSIS OF HARDWARE NETWORK STACK BEHAVIOR

(71) Applicant: Microsoft Technology Licensing, LLC, Redmond, WA (US)

(72) Inventors: Wei BAI, Redmond, WA (US); Jitendra PADHYE, Redmond, WA (US); Shachar RAINDEL, Redmond, WA (US); Zhuolong YU, Yueqing (CN); Mahmoud ELHADDAD, Newcastle, WA (US); Abdul KABBANI, Menlo Park, CA (US)

(73) Assignee: Microsoft Technology Licensing, LLC, Redmond, WA (US)

(21) Appl. No.: 17/887,081

(22) Filed: Aug. 12, 2022

(51) Int. Cl. H04L 41/14; H04L 41/0803; H04L 41/22; H04L 41/00; H04L 67/1095; H04L 43/045

(52) U.S. Cl. CPC H04L 41/145; H04L 41/0803; H04L 41/22; H04L 41/24; H04L 67/1095; H04L 43/045

(57) ABSTRACT

This document relates to analyzing of network stack functionality that is implemented in hardware, such as on a network adapter. The disclosed implementations employ a programmable network device, such as a switch, to inject events into traffic and mirror the traffic for subsequent analysis. The events can have user-specified event parameters to test different types of network stack behavior, such as how the network adapters respond to corrupted packets, dropped packets, or explicit congestion notifications.

### BACKGROUND

In some cases, network stack functionality is implemented in software on a host device. For instance, various operating systems provide an Internet protocol suite that provides transport layer functionality via Transmission Control Protocol (“TCP”) and network layer functionality via Internet Protocol (“IP”). When network stack functionality is provided in software, engineers or administrators can test the network stack using configuration settings or by changing source code. However, recent trends involve implementing network stack functionality in hardware. From the perspective of an engineer or administrator, a hardware network stack implementation from a third-party vendor is a “black box” that can be difficult to test and/or analyze.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to analysis of network stack functionality when implemented in hardware. One example includes a method or technique that can be performed on a computing device. The method or technique includes configuring a programmable network device to inject events into network traffic communicated between two or more hosts having network adapters that perform network stack functionality in hardware. The method or technique also includes obtaining mirrored traffic provided by the programmable network device, where the mirrored traffic includes the injected events. The method or technique also includes analyzing the mirrored traffic to obtain analysis results. The analysis results reflect behavior of the network stack functionality in response to the injected events. The method or technique also includes outputting the analysis results.

Another example includes a programmable network device that includes a plurality of ports and a programmable logic circuit. The programmable logic circuit is configured to receive event parameters of one or more events to inject into network traffic communicated between two or more network adapters connected to two or more of the ports. The programmable logic circuit is also configured inject the one or more events into the network traffic and communicate the network traffic having the one or more injected events between the two or more network adapters. The programmable logic circuit is also configured to mirror the network traffic to one or more other devices for subsequent analysis.

Another example includes a system having a hardware processing unit and a storage resource storing computer-readable instructions. When executed by the hardware processing unit, the computer-readable instructions cause the system to configure a programmable network device to inject events into network traffic communicated between two or more hosts having network adapters that perform network stack functionality in hardware. The computer-readable instructions also cause the system to configure the programmable network device to obtain mirrored traffic provided by the programmable network device, where the mirrored traffic includes the injected events. The computer-readable instructions also cause the system to analyze the mirrored traffic to obtain analysis results. The analysis results reflect behavior of the network stack functionality in response to the injected events. The computer-readable instructions also cause the system to output the analysis results.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1A illustrates an example system, consistent with some implementations of the disclosed techniques.

FIG. 1B illustrates an example orchestration server, consistent with some implementations of the disclosed techniques.

FIG. 1C illustrates an example programmable network device, consistent with some implementations of the disclosed techniques.

FIG. 2 illustrates an example logical test architecture, consistent with some implementations of the present concepts.

FIG. 3 illustrates an example configuration file, consistent with some implementations of the disclosed techniques.

FIG. 4 illustrates an example configuration file, consistent with some implementations of the present concepts.

FIG. 5 illustrates an example of configuration file translation, consistent with some implementations of the present concepts.

FIG. 6 illustrates an example of tracking transmission rounds, consistent with some implementations of the disclosed techniques.

FIG. 7 illustrates an example result table, consistent with some implementations of the disclosed techniques.

FIG. 8 illustrates an example of retransmission latency phases, consistent with some implementations of the disclosed techniques.

FIGS. 9A, 9B, 10A, 10B, 11A, 11B, 12A, 12B, 13A, 13B, 14, 15A, and 15B illustrate examples of analysis results that are output as graphical user interfaces, consistent with some implementations of the present concepts.

FIGS. 16 and 17 illustrate flowcharts of example methods or techniques, consistent with some implementations of the present concepts.

FIG. 18 illustrates an example user interface for configuring events for testing of network stack functionality implemented in hardware, consistent with some implementations of the present concepts.

### DETAILED DESCRIPTION

### Overview

As discussed above, computer networking generally relies on hardware or software network stacks that implement one or more layers of a networking model. For instance, an operating system such as Microsoft Windows can provide TCP/IP functionality by implementing one or more layers of the Open Systems Interconnection (“OSI”) model in software, such as transport, network, and/or data link layers. Software implementations of network stacks can be analyzed and debugged using software tools to evaluate specific behaviors of each layer of the stack using coding tools.

However, software network stack implementations tend to be relatively slow, as they consume computing resources such as CPU and memory. One alternative to implementing network stack functionality in software involves offloading network stack functionality to hardware, such as network adapters. Hardware stack implementations are particularly suited for applications where high throughput, low latency, and/or low CPU overhead are desirable, such as in modern data centers.

To effectively utilize the performance of hardware network stacks, it is useful for network engineers to have an in-depth understanding of how the hardware network stack behaves. However, it is difficult to test hardware network stacks because the operating system kernel does not have direct control over the hardware. As a consequence, conventional tools for testing of hardware network stacks tend to be inflexible and do not allow for analysis of fine-grained device behavior.

The disclosed implementations offer techniques for evaluating and comparing hardware network stack behavior on different devices, such as network adapters. As discussed more below, programmable network devices, such as switches, are used to emulate various network scenarios involving hardware network stacks. A programmable network device can inject events into network traffic communicated between two or more hosts, and mirror the traffic with the events to one or more traffic pooling servers. The use of a programmable network device as described herein allows for deterministic event injection to be configured using user-friendly interfaces that allow engineers to write precise, reproducible tests without necessarily modifying the underlying hardware or directly analyzing the hardware logic of the network devices being tested.

### Definitions

For the purposes of this document, the term “programmable network device” means a network device that can be programmed using instructions to implement specific behaviors, such as parsing of packets and match-action behavior. One example of a programmable network device is an Intel® Tofino™ programmable switch that can be programmed using the P4 programming language. A programmable network device can forward traffic among one or more ports to connected devices. For instance, a programmable network device can use Media Access Control (“MAC)” or other hardware addresses of destination devices to determine on which port to forward received network packets.

In some cases, a programmable network device does not merely forward traffic, but can also inject events into the traffic. An “event” is a modification to traffic received by the programmable network device that is inserted by the programmable network device before forwarding the traffic to its destination address. A programmable network device can “mirror” traffic by sending copies of the traffic to another device, such as a traffic pooling server.

The term “host” means any device connected to a network. Hosts can access the network using a “network adapter” or “network interface card” (NIC) which can physically connect a host to a given network. Some network adapters implement various types of network stack functionality in hardware, referred to herein as a “hardware network stack.” One example of a hardware network stack is a TCP Offload engine or “TOE” that offloads processing of the entire TCP/IP stack to the NIC. This technology can reduce the number of central processing unit (“CPU”) cycles involved in network communications, and can also reduce traffic over a hardware bus such as a Peripheral Component Interconnect Express (“PCIe”) bus.

Another example of a hardware network stack provides remote direct memory access (“RDMA”) functionality to transfer data from pre-registered memory to a network or from the wire to the network. The networking protocol is implemented on the network adapter, thus bypassing the operating system kernel. Hardware RDMA implementations can free CPU cores and accelerate communication-intensive workloads, such as storage and machine learning workloads. Example RDMA implementations include RDMA over Converged Ethernet (RoCE), RoCE version 2 (RoCEv2), and Internet Wide Area RDMA Protocol (iWARP) which runs RDMA over TCP/IP on the NIC.

Another example of a hardware network stack is Scalable reliable datagram (SRD), which is a customized transport protocol that sprays packets over multiple paths to minimize the chance of hotspots and use delay information for congestion control. Unlike TCP and RDMA reliable connection (RC), SRD provides reliable but out-of-order delivery and leaves order restoration to applications.

### Example System

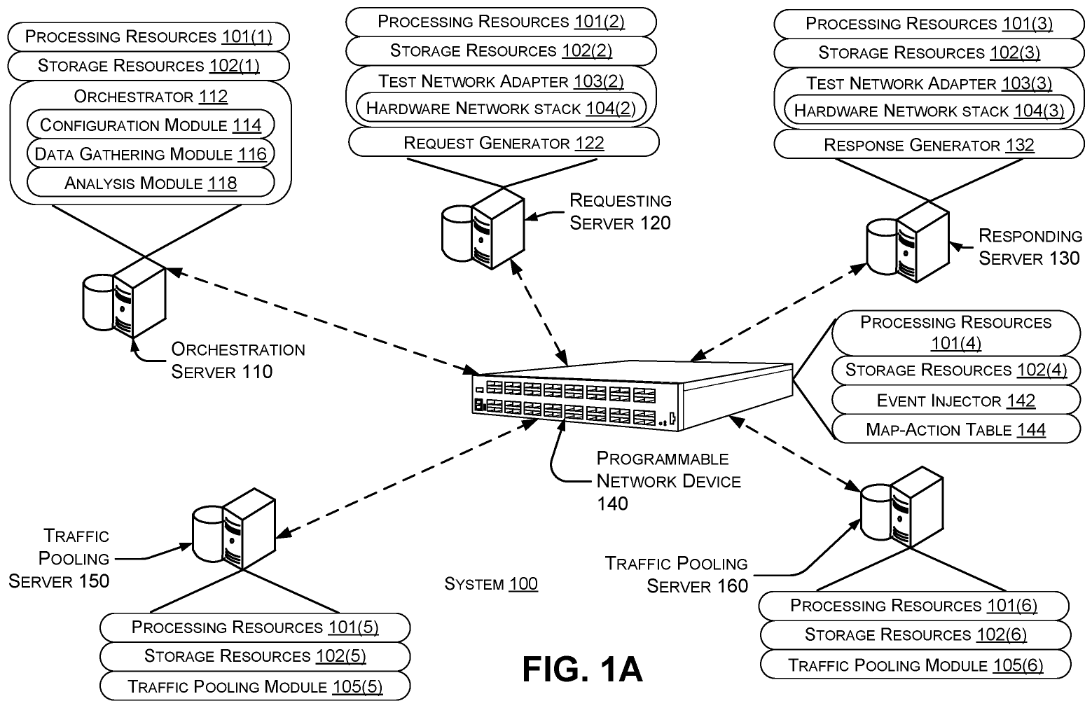

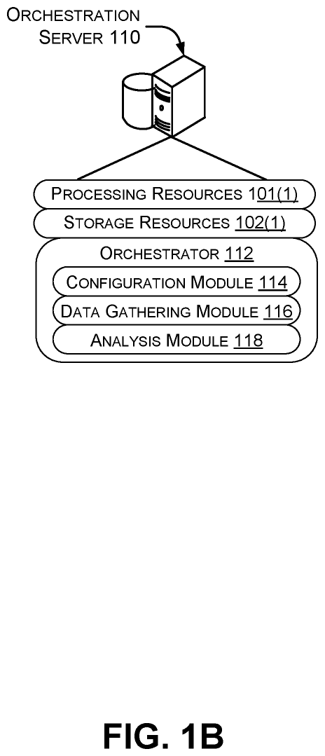

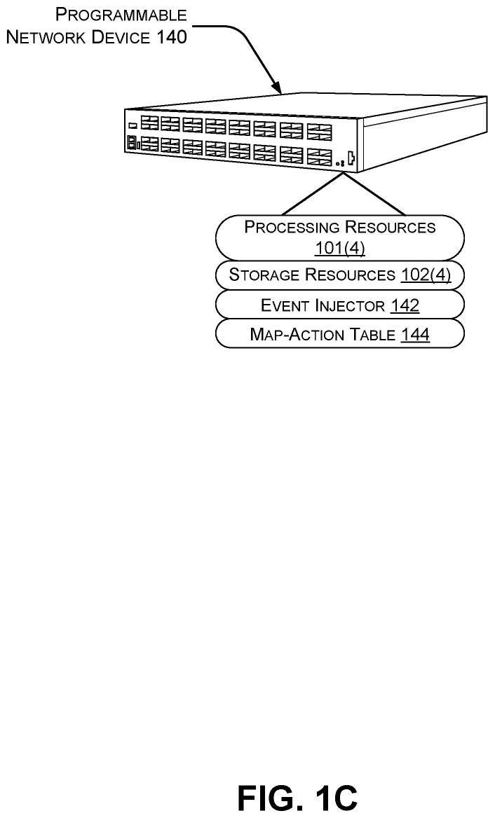

FIG. 1A illustrates an example system 100 with an orchestration server 110, a requesting server 120, a responding server 130, a programmable network device 140, a traffic pooling server 150, and a traffic pooling server 160. FIG. 1B illustrates orchestration server 110 separately, and FIG. 1C illustrates programmable network device 140 separately.

Certain components of the devices shown in FIG. 1A may be referred to herein by parenthetical reference numbers. For the purposes of the following description, the parenthetical (1) indicates an occurrence of a given component on orchestration server 110, (2) indicates an occurrence of a given component on requesting server 120, (3) indicates an occurrence on responding server 130, (4) indicates an occurrence on programmable network device 140, (5) indicates an occurrence on traffic pooling server 150, and (6) indicates an occurrence on traffic pooling server 160. Unless identifying a specific instance of a given component, this document will refer generally to the components without the parenthetical.

Each of the devices in system 100 can include processing resources 101 and storage resources 102. As described more below, storage resources can be any type of device suited for volatile or persistent storage of code or data, e.g., RAM, SSD, optical drives, etc. Processing resources can include any type of device suitable for executing code and/or processing data. In some cases, processing resources can include general-purpose processors such as CPU's. In other cases, e.g., programmable network device 140, the processing resources can include specialized circuits such as an application-specific integrated circuit (“ASIC”). For instance, the programmable network device 140 can be a programmable switch and processing resources 101(4) can include an ASIC programmed using the P4 data forwarding language.

Orchestration server 110 includes an orchestrator 112 that configures network communications and event injections in the system. The orchestrator includes a configuration module 114 that configures the requesting server 120 and the responding server 130 to communicate traffic to one another through programmable network device 140. The configuration module also configures the programmable network device to inject events into the traffic, and to mirror the traffic to traffic pooling server 150 and traffic pooling server 160.

In some cases, the orchestrator 112 configures the programmable network device 140 by sending a configuration file to the programmable network device. The programmable network device can receive traffic sent from the requesting server 120 to the responding server 130, inject events having event parameters specified by the configuration file into the traffic using event injector 142, and forward the traffic to the responding server 130. The programmable network device can also receive responses from the responding server and forward them to the requesting server. The programmable network device can mirror all of the traffic to the traffic pooling server 150 and traffic pooling server 160. In some cases, the event injector configures the events by processing the configuration file received from the orchestrator to modify a map-action table 144.

The requesting server 120 and the responding server 130 can have respective instances of a test network adapter 103(2) and 103(3). The test network adapters can have respective hardware stack instances 104(2) and 104(3), as described more below. The requesting server 120 can have a request generator 122 that generates requests and sends them using test network adapter 103(2) to the responding server 130 via programmable network device 140. The responding server 130 can have a response generator 132 that generates responses and sends them using test network adapter 103(3) to the requesting server 130 via programmable network device 140.

The traffic pooling server 150 and the traffic pooling server 160 can have respective instances of traffic pooling module 105(5) and 105(6), which can collectively store the traffic mirrored by the programmable network device 140. In some cases, the traffic pooling servers employ the same type of network adapter being tested on the requesting and responding servers.

The orchestrator 112 can have a data gathering module 116 that gathers the pooled traffic as well as other results, such as network stack counters, log files, and switch counters. The analysis module 118 can analyze the gathered data and output results of the analysis. As described more below, the analysis results can reflect network stack behavior implemented in hardware on the test network adapters 103.

### Example Logical Test Architecture

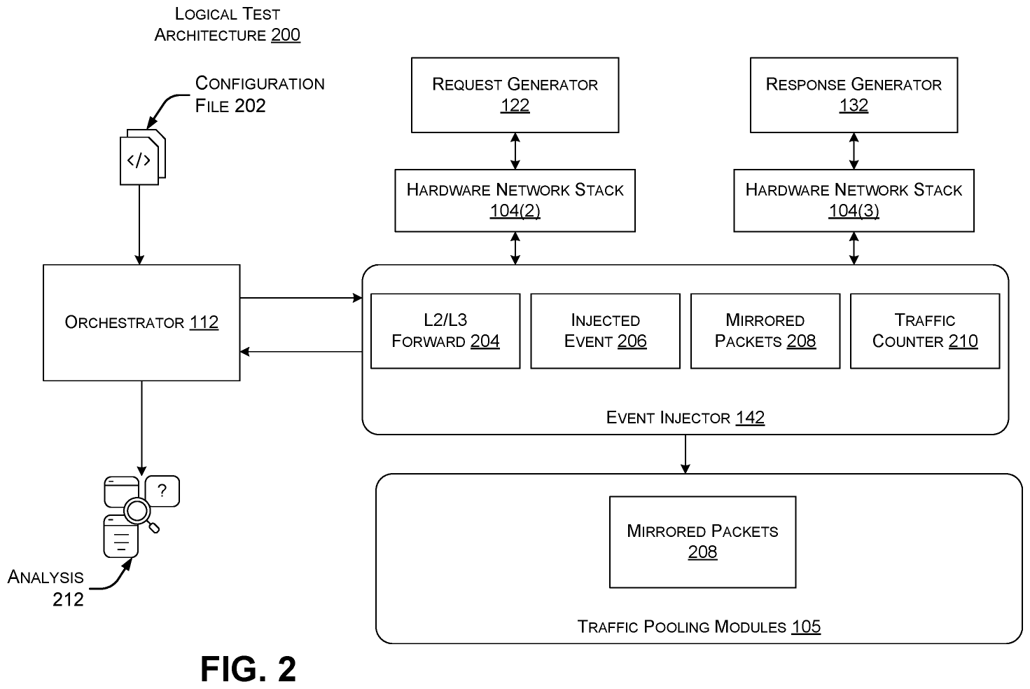

FIG. 2 illustrates an exemplary logical test architecture 200 that conveys how certain components of system 100 can interact to test a hardware network stack implementation. To run a test, the orchestrator 112 takes a configuration file 202 as input, sets up a test environment, and sends commands, such as Remote Procedure Calls (RPCs), to each component to coordinate their executions.

The request generator 122 can communicate request traffic as instructed by the orchestrator, where at least some network stack functionality is offloaded from software to the hardware network stack 104(2). The response generator 132 can communicate response traffic as instructed by the orchestrator, where at least some network stack functionality is implemented by the hardware network stack 104(3).

The event injector 142 forwards the traffic via L2/L3 forwarding 204 and injects events 206, such as explicit congestion notification (ECN) marks, packet losses, and/or packet corruptions. The event injector also sends mirrored packets 208 to the traffic pooling modules 105 and maintains a traffic counter 210.

Once the traffic finishes, the orchestrator 112 collects results from the other components, e.g., mirrored packets, counters, log files, etc. The orchestrator reconstructs the complete packet trace from dumped packets collected by the traffic pooling modules 105 and can then parse the packet trace to analyze behaviors of the hardware network stack to output an analysis 212.

### Traffic Generation Configuration File

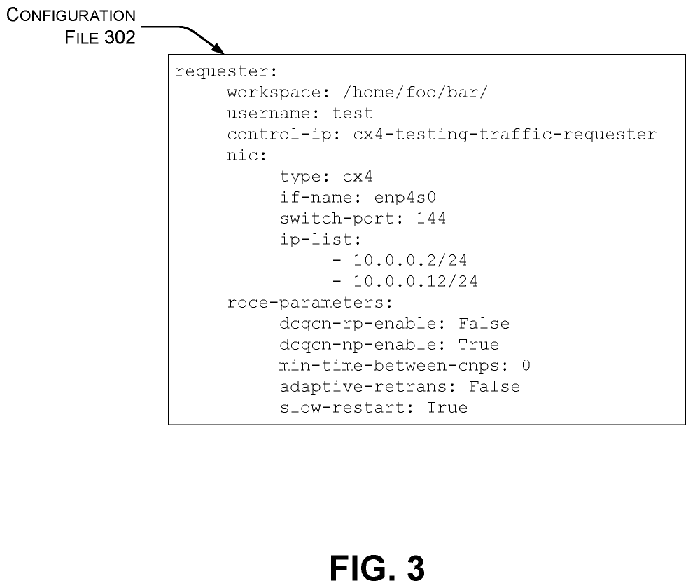

Before starting traffic generation by the request generator 122 and the response generator 132, the orchestrator 112 first configures IP addresses and network stack settings, e.g., congestion control and loss recovery parameters, of requesting server 120 and responding server 130. FIG. 3 gives an example of a configuration file 302 that can be employed in this regard. In the following description, the requesting server 120 and responding server 130 are sometimes collectively referred to as the “traffic generating hosts,” and the request generator 122 and response generator 132 are sometimes collectively referred to as “traffic generators.” The following examples show how RDMA network stack functionality can be tested using RoCEv2 packets, but can be readily extended to other types of network stack implementations.

After configuration, the orchestrator instructs the traffic generating hosts to initiate traffic generation. For instance, the traffic can be generated using Reliable Connected (RC) transport, supporting RDMA send, receive, write, and read verbs, denoted as SEND, RECV, WRITE and READ. The request generator 122 and response generator 132 communicate using one or multiple queue pairs (QPs). As shown in FIG. 3, the configuration file can specify many parameters of traffic generators, e.g., the number of QPs, retransmission timeout, and MTU (maximum transmission unit).

After objects such as QPs and memory regions (MRs) are initialized by the hosts, they exchange metadata, e.g., QP number (QPN), packet sequence number (PSN), global identifier (GID), memory address and key, through a TCP connection. Since QPNs and PSNs are randomly generated at runtime and useful for the event injector to correctly identify packets, the hosts can send the metadata information to the event injector 142 as well.

After exchanging metadata and establishing QP connections, the request generator 122 posts work requests to generate RDMA traffic. The request generator controls the total number of requests/messages and the maximum number of outstanding requests on each QP. In the case of SEND/RECV, the response generator 132 continues posting corresponding RECV requests. The request generator can support barrier synchronization among QPs by posting the next round of requests only after receiving the completions of the current round of requests across all the QPs. Thereafter, when the request generator 122 receives completions of all the requests, the request generator can calculate metrics such as request/message completion times and total goodput, and send a completion notification to the response generator through the TCP connection.

### Event Injection Configuration File

To emulate realistic network scenarios like congestion and failures, the event injector 142 can be programmed via a configuration file to inject packet corruptions, packet drops and ECN marks to RDMA data packets. Generally, the response generator 132 can generate data packets for READ while the request generator 122 can generate data packets for the other verbs.

The disclosed implementations aim to provide user-friendly interfaces for engineers to express a series of deterministic injection events. To provide precise, reproducible results, the events can be deterministic, e.g., instead of randomly dropping a specified percentage of packets, the events can be specified more precisely, e.g., “drop the first packet of the first QP” can generate deterministic injection behaviors. This allows a user to express their high-level testing intents without the need to understand low-level details, e.g., a user can configure the programmable network device to drop the first packet of the second QP, then drop the retransmission of this packet. The user does not need to specify QPN and PSN for each QP, nor understand how the event injector 142 identifies the retransmitted packet.

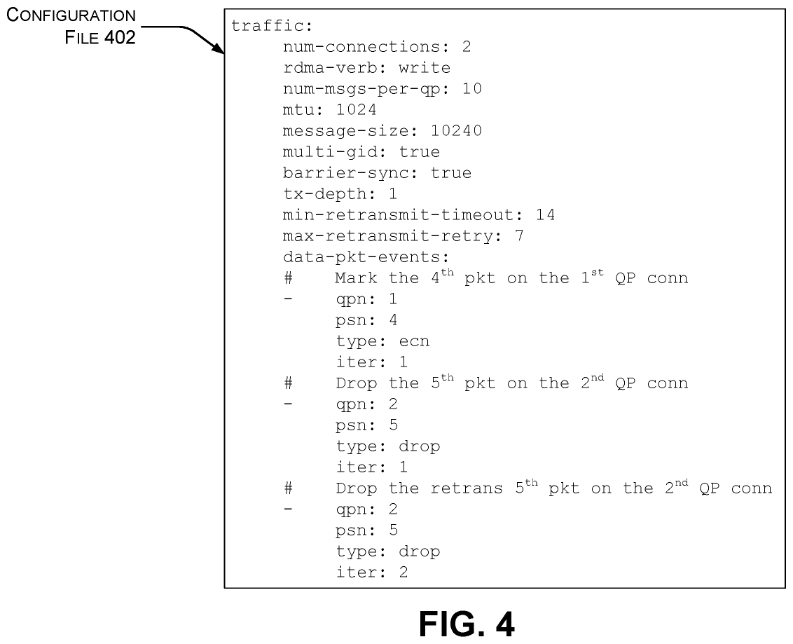

FIG. 4 gives an example of a configuration file 402 that implements event injections. There are three events across two QP connections. In some implementations, the event injector 142 only preserves the order of events on the same QP connection. The events of different QP connections are independent. On the first QP, the fourth packet is marked, on the second QP, the fifth packet is dropped initially and then again when the sender retransmits this lost packet. Users can use the configuration file to specify relative QPNs and PSNs, and can use the iter field to express retransmission rounds. This allows location of retransmitted packets which have same QPN and PSN as the original packets.

### Configuration File Translation

The programmable network device 140 can translate high-level test intents (e.g., relative QPN and PSN) expressed in the configuration file to the low-level configuration for event injection. An iteration number (ITER) can be employed to express per-connection retransmission behaviors.

As noted, a configuration file can provide high-level intent information such as relative PSN and QPN. In some implementations, the event injector 142 can detect new QPs and parse their QPNs and initial PSNs on the data plane. However, this stateful approach tends to complicate the data plane because, for every RDMA packet, the event injector first checks if it belongs to a new QP. If yes, the event injector 142 further needs to initialize states for this new QP.

Other implementations employ a stateless approach by leveraging traffic generators to provide runtime traffic metadata. As mentioned above, traffic metadata like QPN and initial PSN (IPSN) is randomly generated at runtime. Once the traffic generator instances finish exchanging metadata through TCP, the request generator 122 sends the complete traffic metadata to the event injector 142 through the control plane. The metadata is organized as a list of tuples. Each tuple contains the information for a certain QP connection: requester IP/QPN/IPSN and responder IP/QPN/IPSN. After that, the event injector combines the runtime traffic metadata from traffic generators and traffic configuration intents from the orchestrator 112 to populate the match-action table for event injections. After the event injector populates the table, the requesting server 120 and responding server 130 can start communicating RDMA traffic.

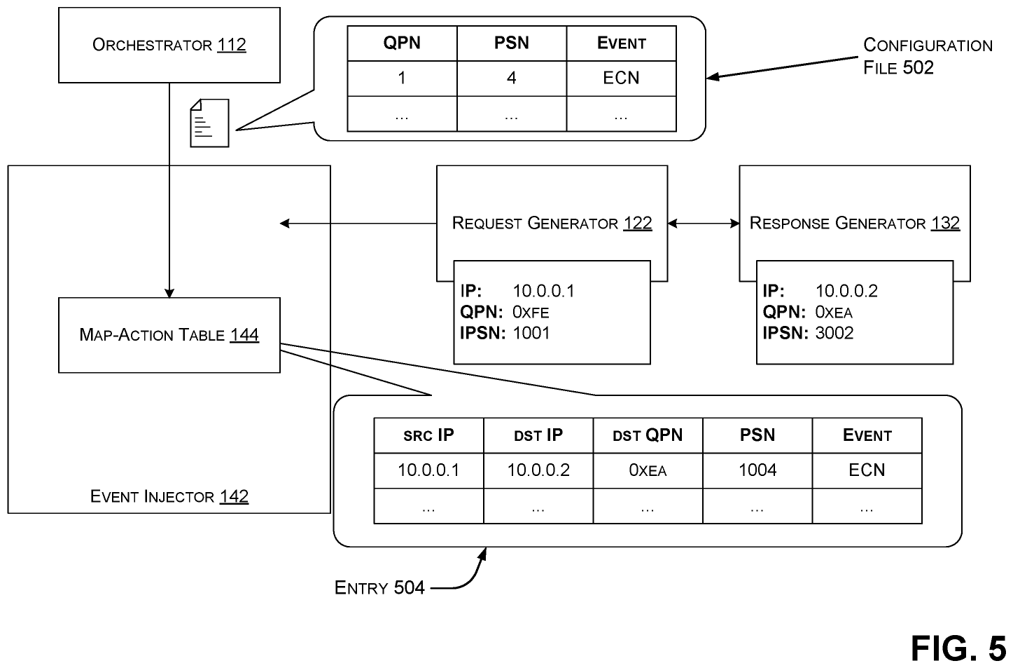

FIG. 5 shows an example where the IP address, QPN, and IPSN of the QP of the request generator 122 are 10.0.0.1, 0xfe, and 1001, respectively. The IP address, QPN, and IPSN of the QP of the response generator 132 are 10.0.0.2, Oxea, and 3002, respectively. Data packets are sent from the request generator to the response generator. The configuration file 502 instructs the event injector 142 to include an ECN marking in the fourth packet of the first QP connection. By combining above information, the event injector computes and inserts the following entry 504 into the map—action table: if the source IP, destination IP, destination QPN, and PSN fields of a RoCEv2 packet are 10.0.0.1, 10.0.0.2, Oxea, and 1004 (1001+4−1), respectively, the programmable switch will mark ECN for this packet.

### Express Retransmission

In some cases, users wish to inject events to retransmitted packets to understand behaviors like retransmission timeout backoff. However, the retransmitted packet cannot necessarily be differentiated from the original packet by looking into the RoCEv2 packet header since they have the same IP addresses, UDP ports, QPN and PSN.

Thus, some implementations employ an iteration number ITER, which denotes the rounds of transmissions for a connection. ITER starts from 1 and is maintained by the event injector 142. For every arriving packet, the event injector compares its PSN with PSN of the last packet of its connection. If PSN of the current packet is not larger than that of the previous packet, the event injector identifies this as a new round of transmissions and increases ITER of this connection by 1. Regardless of the comparison result, the event injector always updates PSN of the last packet of the connection using PSN of the current packet. Thus, PSN, ITER can be used to uniquely identify every packet in a connection prior to injecting events.

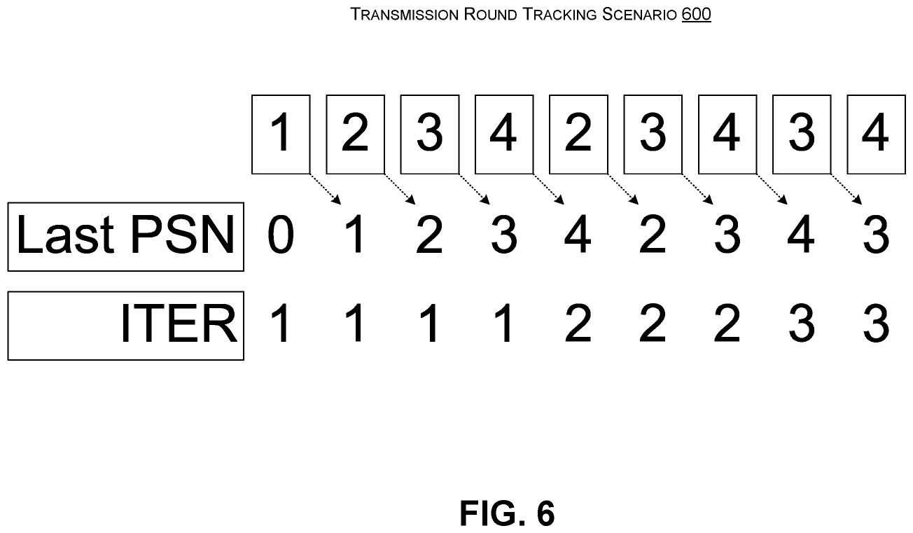

FIG. 6 gives an example transmission round tracking scenario 600 using ITER to track transmission rounds. In this scenario, there is only a single connection and the configuration file instructs the event injector to drop the second packet in the first round (PSN=2, ITER=1), and the third packet in the second round (PSN=3, ITER=2). The sender transmits four packets. ITER is initialized as 1 and the last PSN is set to IPSN-1, which is 0 in this case. In the first iteration, packet 2 is dropped. When packet 2 is retransmitted, the current PSN (2) is smaller than the last PSN (4), thus triggering a new round of transmissions (ITER=2). Likewise, by dropping packet 3 in the second round, the retransmission of packet 3 triggers a new round (ITER=3).

### Traffic Pooling

Some implementations can dump all communicated packets between traffic generators to one or more pooling servers for offline analysis. One approach would be to employ tools like ibdump to dump packets at the end host. However, traffic dumping at the end host could plausibly impact behaviors of network stacks. Furthermore, reconstruction of the complete packet trace from packets dumped at both traffic generation hosts could involve nanosecond-level clock synchronization, which is non-trivial.

Thus, in some implementations, the event injector 142 is configured to mirror all the packets to a group of dedicated traffic pooling servers. Packet mirroring essentially clones packets of specified interfaces and forwards them to other interfaces for examination. For instance, all packets at the ingress pipeline can be mirrored before actually dropping any packets by the programmable network device 140. Ingress mirroring instead of egress mirroring allows capture of original behaviors of hardware network stacks.

For the ease of integrity check and traffic analysis, the event injector 142 can embed certain metadata in mirrored packets. To avoid losses during packet dumping, a per-packet load balancing mechanism can be employed to evenly distribute mirrored packets across CPU cores of traffic pooling servers 150 and 160.

### Embedding Metadata in Mirrored Packets

In some implementations, the event injector 142 embeds three types of metadata, mirror sequence number, event type and mirror timestamp, in mirrored packets for the following purposes.

1. Integrity check. As mirrored packets are employed to understand behaviors of the hardware network stack, it is useful to ensure that all the packets are mirrored and stored by the traffic pooling servers. To this end, the event injector maintains a global variable, mirror sequence number, which is incremented for every arriving RDMA packet and embedded in each mirrored packet. Together with switch port counters, subsequent analysis can verify if there is any packet loss. If all the packets are dumped, the resulting trace should include consecutive mirror sequence numbers, and the largest mirror sequence number should match the total number of received packets.

2. Indicating events. For subsequent analysis of mirrored packets, the event injector 142 can include an event type in each packet to indicate the injected event, e.g., the event types can include ECN marking, packet drop, packet corruption, no event, and so on. Note that all packets can be mirrored at the ingress pipeline before packets are dropped.

3. Fine-grained measurement. To accurately measure behaviors of the hardware offloaded network stack, the event injector 142 can embed a mirror timestamp in each mirrored packet, which carries the nanosecond-level time when the original packet enters the ingress pipeline. Since the event injector adds timestamps to all the packets, it does not necessarily require clock synchronization.

To embed the above metadata in mirrored packets, one approach involves expanding packets with new fields storing these metadata. However, this may overload the bandwidth capacity of mirroring ports if original traffic's throughput is close to line rate. To avoid this, the event injector can rewrite existing header fields that are not involved in traffic analysis to store above metadata. In some implementations, the Time to Live (TTL) field, the source MAC address field, and the destination MAC address field are used to store event type, mirror sequence number, and mirror timestamp, respectively.

### Load Balancing

One approach for pooling traffic involves using separate hosts to store mirrored packets generated by the requester and the responder, respectively. However, this approach may result in discarded packets when receiving line-rate mirrored packets. Although these invalid tests can be identified by integrity checks, this degrades efficiency. Thus, some implementations employ a per-packet load balancing mechanism to evenly distribute mirrored packets across CPU cores of multiple traffic pooling servers. The user can flexibly set up hosts as long as the total capacity of the pooling servers is sufficient to process bi-directional line-rate traffic with minimum-sized packets. The event injector 142 can implement a weighted round-robin load balancing scheme to forward mirrored packets to different traffic pooling servers based on their processing capacity. Though the requester and responder generate traffic at heterogeneous rates, the event injector can evenly distribute mirrored packets to homogeneous traffic pooling servers.

At each traffic pooling server, Receive Side Scaling (RSS) can be employed to distribute packets across multiple CPU cores. However, RSS preserves flow to CPU affinity by hashing certain packet fields to select a CPU core. As a result, the CPU processing capacity depends on the number of flows in the test. To fully exploit CPU cores, the event injector 142 can be configured to rewrite the UDP destination port to a random number. Note that UDP destination port number 4791 is reserved for RoCEv2. By rewriting this port number, an illusion of many concurrent flows to RSS can be created, thus efficiently leveraging CPU processing capacity.

### Result Collection and Integrity Check

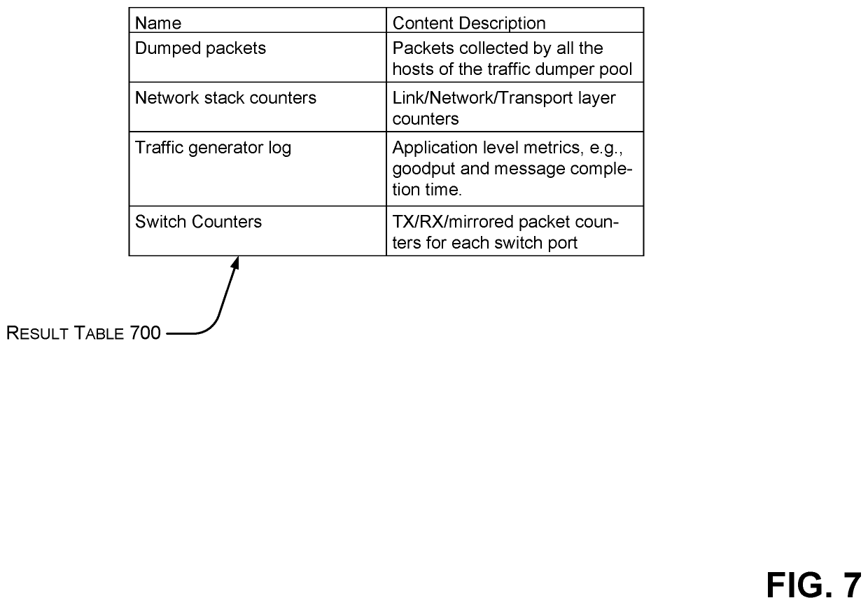

Once traffic generators stop, the orchestrator 112 terminates all the other components and collects various result files shown in result table 700, shown FIG. 7. The orchestrator collects mirrored packets from all the traffic pooling servers, hardware network stack counters and traffic generator log files from the traffic generating hosts, and switch counters from the event injector 142.

Upon collecting all the result files, the orchestrator 112 reconstructs the packet trace from packets collected by the traffic pooling servers. Since the event injector 142 maintains the mirror sequence number and stores this on the source MAC address field of each mirrored packet, the orchestrator can sort all the packets based on their mirror sequence numbers.

After the packet trace reconstruction, the orchestrator 112 runs an integrity check using the following four conditions to determine if the packet trace is complete without losses of any packets during traffic mirroring and dumping:
1. Mirror sequence numbers in the trace are consecutive.
2. Mirror timestamps in the trace keep increasing unless the timestamp wraps around.
3. The number of packets in the trace equals the total number of packets mirrored by the event injector.
4. The number of packets in the trace equals the total number of RDMA packets received by the event injector.

If these conditions hold, a complete traffic trace has been constructed. Otherwise, an error can be reported to convey that the test data is invalid and that analysis based on the collected test data is unlikely to be accurate.

### Analysis

Once a given test passes these integrity checks, reconstructed packet traces, log files, and counters can be analyzed. In some cases, the analysis module 118 of orchestrator 112 provides a set of built-in analyzers for certain features in RDMA, e.g., Go-back-N retransmission and ECN-based congestion control.

Retransmission logic. Retransmission can be tested to ensure reliable delivery. In some implementations, a retransmission logic analyzer is employed to check if the network adapter follows the corresponding specification when a packet is dropped. For instance, a network adapter that implements the Go-back-N specification should generate a negative-acknowledgement (“NACK”) packet when it receives out of order arriving packets. To realize this, the specification of Go-back-N can be translated into a finite-state machine (FSM) and the reconstructed packet trace can be fed into this FSM. If the packet trace is not accepted by the FSM, the network adapter's retransmission implementation does not fully comply with the specification.

Retransmission performance. In some cases, RDMA is employed over lossy networks. Lossy RDMA technologies heavily rely on efficient retransmission implementations. For example, when a network adapter receives a NACK packet or a selective acknowledgement (“SACK”) packet, ideally the network adapter will start the retransmission immediately, rather than wait for a long time.

To analyze retransmission performance of a given network adapter, a retransmission performance analyzer can be employed. Note that this tool can be used in combination with the above retransmission logic analyzer to determine if the network adapter under test has a correct and efficient retransmission implementation. The retransmission performance analyzer can deal with both fast retransmissions (triggered by NACK/SACK) and timeout retransmissions (due to tail losses), and provide the performance breakdown to help users to identify the bottleneck.

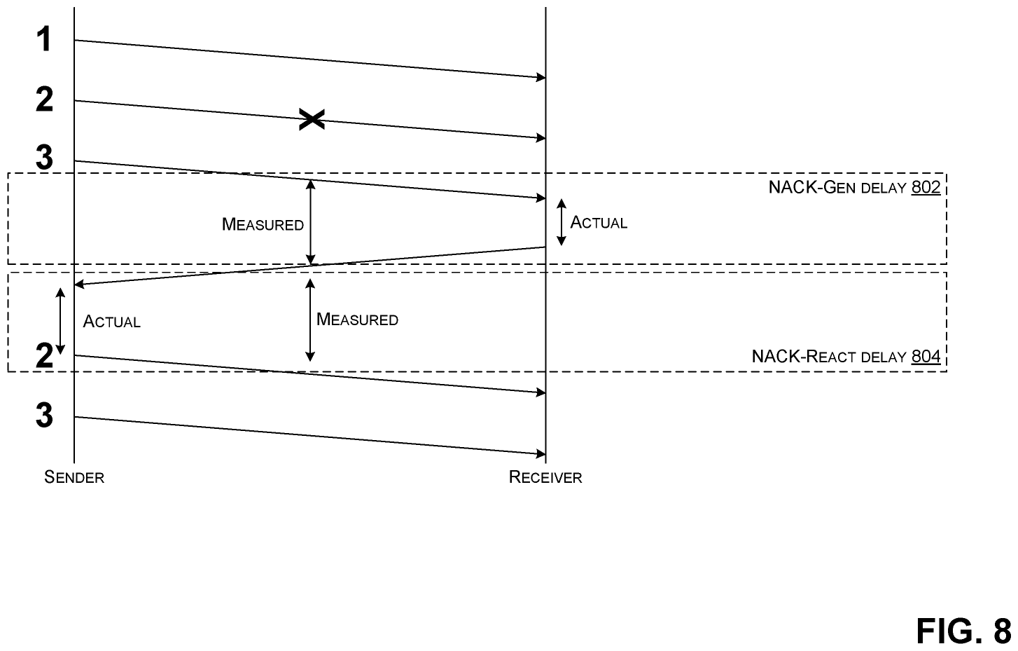

FIG. 8 shows how a NACK-triggered retransmission can be broken into two phases: NACK generation phase (receiver side) 802 and NACK reaction phase (sender side) 804. The NACK generation phase is the time between the receiver detecting an out-of-order packet and transmitting a NACK. The NACK reaction phase is the time between the sender getting a NACK and starting retransmission. Note that there is a half of a round-trip time (“RTT”) deviation since the timestamp is added by the middlebox rather than the end host. This deviation can be reduced by pre-measuring the RTT of the testbed.

Congestion notification. Data center quantized congestion notification (“DCQCN”) is the de facto RoCEv2 congestion control protocol implemented in certain network adapters. Once the DCQCN notification point (NP, receiver) receives ECN-marked packets, the receiver notifies the reaction point (RP, sender) to reduce the rate using Congestion Notification Packets (CNPs). Recent network adapter models extend DCQCN to lossy networks. When the notification point receives out-of-order packets, it generates both NACKs and congestion notification packets (CNPs) to notify the reaction point to start the retransmission and lower the sending rate. In addition, to reduce the volume of CNP traffic and the CNP processing overhead, some network adapters also have a CNP pacer at the notification point side, which determines the minimum interval between two consecutive generated CNPs.

In summary, the generation of CNPs depends on ECN-marked packets, packet losses and the CNP pacer configuration. In some cases, the orchestrator 112 provides an CNP analyzer to check if CNPs are generated as expected under various network conditions and CNP pacer configurations.

Hardware network stack counter. Some implementations also employ a counter analyzer to check if counters of the hardware network stack are updated correctly. Counters can be provided for retransmission, timeout, congestion and packet corruption, counters of sent/received packets, sequence errors, out-of-sequences, timeouts (and retry), packets with redundancy coding errors, discarded packets, CNPs sent/handled, etc.

### Additional Event Injection and Mirroring Details

In some implementations, the event injector 142 modifies packets and set a drop flag at the ingress pipeline. The events are injected by manipulating the packet field or intrinsic metadata. The egress pipeline includes a module to rewrite packet fields of mirrored packets. Both incoming and outgoing packets are tracked, including mirrored packets, on each port for integrity check. The switch control plane can be coded to translate RPC calls to configure the data plane modules and dump port counters after a given experiment finishes.

In some implementations, the traffic generator hosts employ Libibverbs to generate RDMA traffic over RC transport. A traffic generator can control the IP associated with each QP to emulate traffic from multiple hosts. A traffic generator can also report total goodput and average request/message completion times for each QP.

The traffic pooling hosts can be configured using data plane development kit (“DPDK”) and Receive Side Scaling (RSS) to dispatch the packets among the receiver queues and cores. The traffic pooling hosts can buffer packets in the pre-allocated memory during a given test and write the packets to storage upon receiving a TERM message from the orchestrator.

### Experimental Configuration

The disclosed implementations were employed to conduct experiments on three commercially-available network adapters, referred to below as NIC A, NIC B, and NIC C. Each test was conducted using a total of four servers connected to a network switch with a programmable ASIC, which works as the event injector. Each server had a multi-core CPU and a corresponding NIC card running a Linux-based operating system. Two traffic generating servers were used to generate traffic, and two traffic pooling servers were used to dump mirrored packets.

### Overhead Experiment

Overhead of event injection and mirroring. An experiment was conducted to test the overhead of event injection and traffic mirroring. The traffic generator was configured to continue sending 1000 messages with a fixed size over a single QP, and the average message completion time (MCT) was measured. The messages were sent back-to-back and the experiment with was conducted with different message sizes: 1 KB, 10 KB and 100 KB.

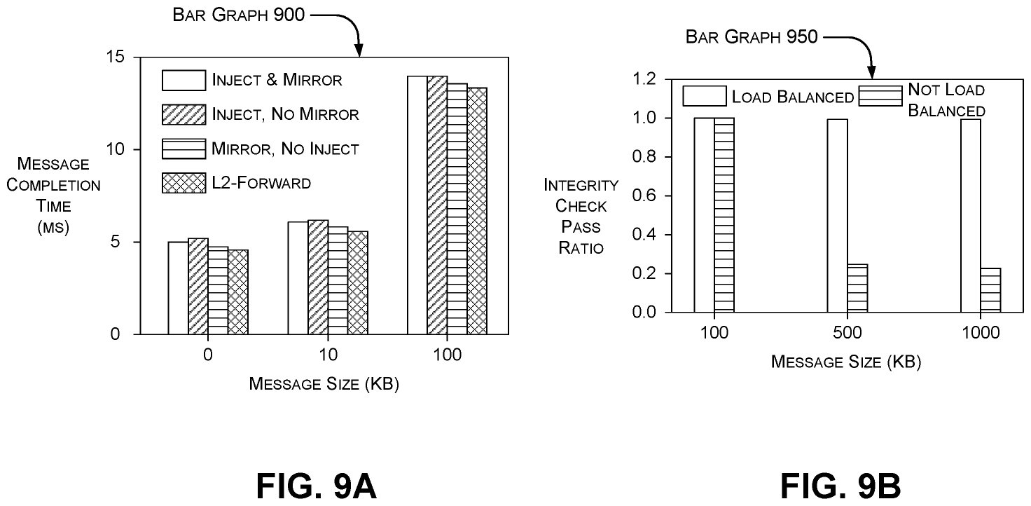

FIG. 9A shows a bar graph 900 with message completion time results for four configurations—event injection with mirroring, event inject without mirroring, mirroring without event injection, and L2-forwarding without event injection and without mirroring, which was employed as a baseline. For event injection with mirroring, the match-action tables were preserved while disabling drop behavior to avoid retransmissions.

As shown in FIG. 9A, event injection introduces negligible overhead, with an MCT of only 4.1-7.2% higher than that of mirroring only and L2-forwarding without event injection and without mirroring. Mirroring adds little overhead to the under-test traffic, delivering almost the same message completion time as without mirroring.

### Load Balancing Experiment

Benefit of per-packet load balancing. The efficiency of the disclosed techniques depends to some extent on the reliability of packet dumping. FIG. 9B shows a bar graph 950 with results indicating how per-packet load balancing can provide efficiency for traffic mirroring and dumping phase. Messages were sent with different sizes (100 KB, 500 KB and 1 MB respectively) at line rate and with the switch mirroring and load balancing. Another version without per-packet load balancing (mirror traffic from an ingress port to a specific server) was implemented as a comparison.

The experiment was run for 100 rounds, the ratio of rounds that pass an integrity check was measured. As shown in FIG. 9B, with per-packet load balancing, the disclosed implementations can achieve approximately 100% pass ratio irrespective of message size, as shown by the load balanced results. However, the message gets larger, the pass ratio of the version without load balancing is as low as 23%, as shown by the non-load balanced results.

### First Retransmission Experiment

When packets in the middle are dropped, the receiver can observe out-of-order packets and generate NACK or SACK to trigger fast retransmissions. NICS A, B, and C adopt Go-back-N as the default fast retransmission algorithm. The disclosed techniques were used to evaluate fast retransmission behaviors of these NICS by deliberately dropping packets. All of the network adapter models passed the FSM-based retransmission logic check described previously, indicating that their retransmission implementations follow the specification.

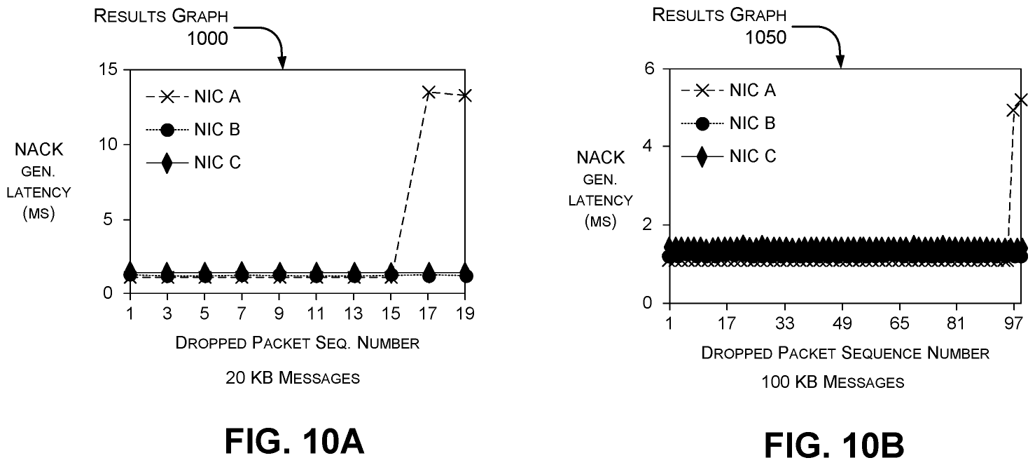

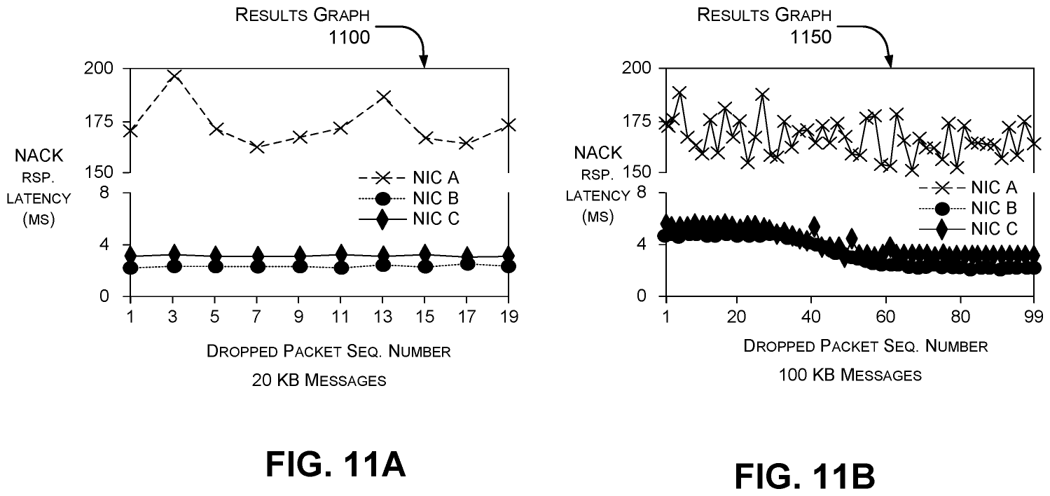

Setting. In this experiment, a traffic generator uses one connection to generate WRITE traffic with only a single outstanding request. For each message, one packet was dropped with a different (relative) PSN. Message size was fixed as 20 KB and 100 KB respectively. The experiment was run for 1000 iterations and the average latency was computed. The Go-back-N retransmission latency was broken into two parts: the NACK generation latency and the NACK reaction latency. FIG. 10A shows a results graph 1000 for NACK generation latency with 20 KB messages, and FIG. 10B shows a results graph 1050 for NACK generation latency with 100 KB messages. FIG. 11A shows a results graph 1100 for NACK reaction latency with 20 KB messages, and FIG. 11B shows a results graph for NACK reaction latency with 100 KB messages.

Performance improvement. As shown in FIG. 10A, significant improvement on retransmission performance from each subsequent network adapter version. As shown in FIG. 10A, if one of the last several packets is dropped (e.g., the 19th packet in FIG. 10A) for NIC A, the NACK generation latency (13-1 μs) is much larger than the latency when other packets are dropped (about 1.1 μs). On the other hand, for NICS B and C, the NACK generation latency statically stays around 1.1 μs. Further, note the NACK reaction latency of NIC A (150-200 μs) is much larger than that of NICS B and C (3-6 μs). Thus, NICS B and C provide significant improvement (˜200 μs v.s.˜4.5 μs) over NIC A in terms of retransmission performance.

Retransmission might be blocked. While NICS B and C deliver low NACK reaction latency, the NACK reaction latency still varies. As shown in FIG. 11B, when the message size is 100 KB, the NACK reaction latency is about 6 μs if one of the first 20 packets is dropped, while it is about 3 μs if a later packet is dropped.

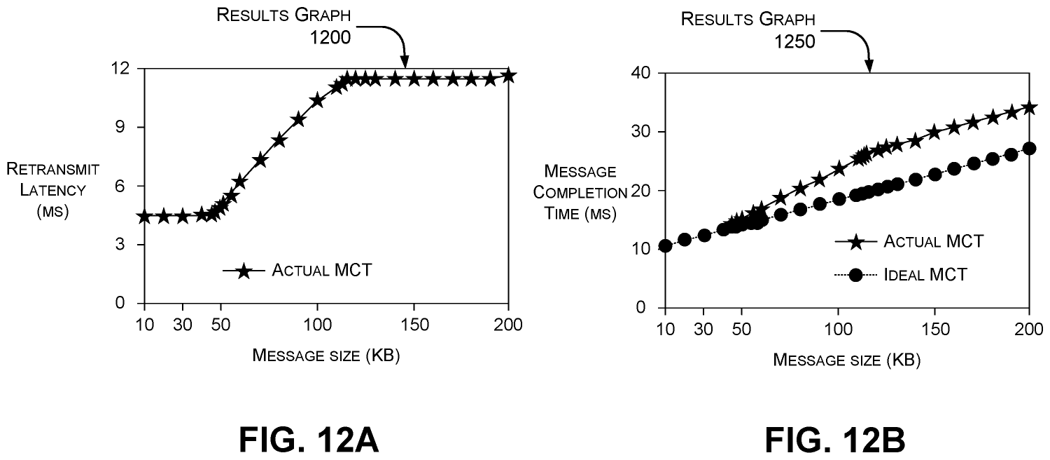

Another set of experiments was conducted to further investigate this behavior. This time, the effect of message size was investigated by dropping the fifth packet of a message and varying the message size from 10 KB to 200 KB. The packets are sent back-to-back. FIG. 12A shows a results graph 1200 that plots the retransmission latency of NIC C for different message sizes when the fifth packet is dropped. The retransmission latency starts growing when the message size is around 50 KB, and becomes constant after the message size is larger than 120 KB. This trend reflects in the message completion time (MCT). FIG. 12B shows a results graph 1250 showing the “Actual MCT” plotted based on the output from traffic generator, and the “Ideal MCT” which is the sum of MCT without retransmission and a fixed “ideal” latency 4.5 μs. When message size is between 50 KB to 120 KB, the “Actual MCT” grows faster than “Ideal MCT.”

One plausible explanation for this anomaly: retransmitted packets and original packets share the same transmission pipeline on the NIC, and retransmitted packets cannot preempt original packets that are already in the pipeline. As a result, retransmitted packets may be delayed. When the sender transmits a packet, it may push the packet to the tail of the pipeline no matter whether it's a retransmitted packet or a normal packet. If the message is short (e.g., 10 KB), the pipeline is already empty when the retransmission happens because all the packets have been transmitted. Otherwise, the pipeline might still retain a few packets that haven't been sent when a packet is going to be retransmitted, if the message is relatively large (e.g., 100 KB). This is one example of an analytical inference that a user can make from experiments conducted using the disclosed techniques.

### Second Retransmission Experiment

When tail packets or retransmitted packets are dropped, the sender can only use the retransmission timer to recover them. Inappropriate timeout values can lead to either spurious retransmissions or poor tail performance. In this section, findings related to timeout retransmissions are reported.

Setting. When creating QPs, Libibverbs provides an interface to configure the timeout and retry_cnt value. Default values were employed. timeout is set to 14, meaning that the minimum timeout is 4.096 μs*2^{timeout}=0.0671 s [45]. retry_cnt indicates the maximum number of times that the QP will try to resend the packets before reporting an error, and was set to 7.

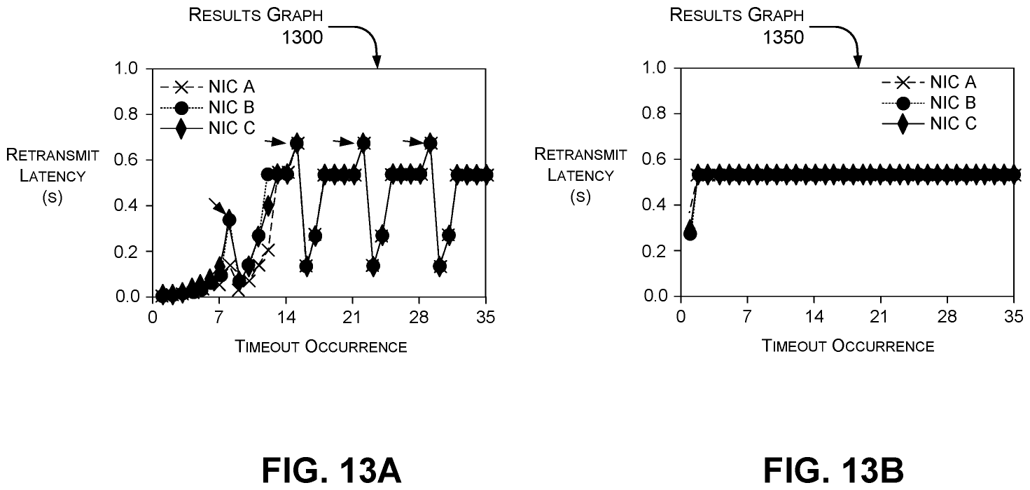

In the experiment, the programmable network device continues dropping the tail packet to trigger timeouts. Specifically, one connection is used to send 5 WRITE messages. For each message, the size is 10 KB, and the tenth (tail) packet is dropped for 7 (retry_cnt) times. Experiments were run in both adaptive and non-adaptive mode (default) respectively. The results are shown in FIGS. 13A and 13B as adaptive results graph 1300 and non-adaptive results graph 1350, respectively.

Unexpected timeout value. When adaptive retransmission is enabled, the actual timeout value changes according to the packet loss frequency. It is worth noting that except for the first message, the first timeout of a message jumps to a high level unexpectedly (e.g., 0.267 s for the second message and 0.671 s for the latter messages). Furthermore, the timeout value is not bounded by the pre-configured 0.0671 s: for the first message, some of the retransmission timeouts are smaller than 0.0671 s: 0.0056 s, 0.0041 s, 0.0084 s, 0.0167 s, 0.0251 s, and 0.1342 s. For non-adaptive retransmission, the timeout value obeys the specification: the first timeout is around 0.2-0.4 s, then the following timeouts are static at about 0.537 s. All these values are larger than the minimum timeout 0.0671 s.

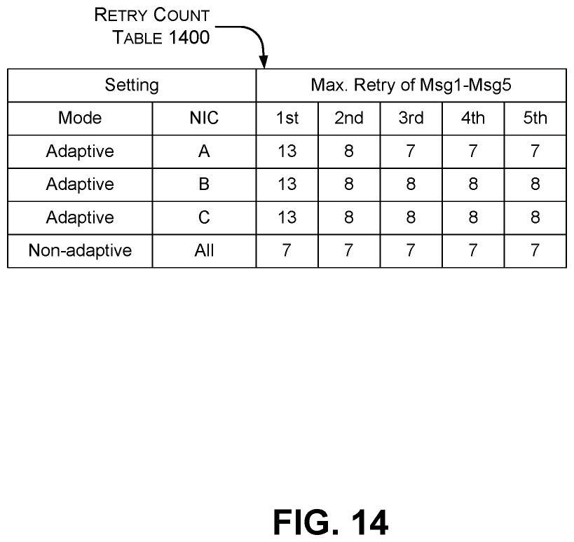

Retry times. Experiments also revealed that the maximum retry times is correctly enforced in non-adaptive mode, but not necessarily in adaptive mode. 5 WRITE messages were sent while dropping the last packet of each message until an error was reported. FIG. 14 shows retry count table 1400 for the network adapters in both adaptive mode and non-adaptive mode. All the network adapters work correctly under non-adaptive mode as they retry for 7 times exactly as retry_cnt specifies. However, in adaptive mode, the first message can retry for 13 times and the later message can retry for 7 or 8 times. The maximum retry attempts also vary between different network adapter models. For example, for the third message, NIC A can retry 7 times, while NICS B and C can retry 8 times. One plausible explanation is that, since the timeout value is static in non-adaptive mode, quality of service can be ensured by enforcing a fixed total retry count. In adaptive mode, as the timeout is adaptively changing, the retry count may be adjusted according to other patterns (e.g., time spent for retransmission).

### Cnp Experiment

Another experiment illustrates congestion notification packet (CNP) generation, which is employed for congestion control. The following experiments were conducted to determine whether CNP generation of one connection would be affected by ECNs or losses from another connection.

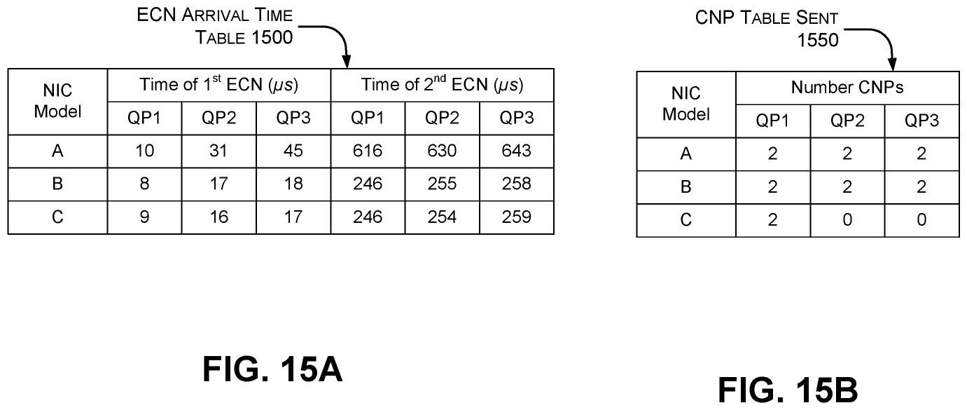

Setting. This experiment was conducted using three connections, each sending a 1 MB WRITE message. All the three connections have the same responder address (10.0.0.1) but different requester addresses (10.0.0.11, 10.0.0.12, and 10.0.0.13) to simulate a scenario that three requesters are sending WRITE traffic to one responder. The QPs at the responder side are denoted as QP1, QP2 and QP3 respectively. The network adapters employed use a parameter named min_time_between_cnps to control the CNP generation interval. In this experiment, min_time_between_cnps was set to 50 μs. The three connections are sending traffic simultaneously, and ECN was marked for the 50-th packet and the 950-th packet of each connection. The DCQCN reaction functionality in the requester was disabled to avoid adjusting the sending rate upon receiving CNPs. After the experiment, the mirrored traffic is analyzed to determine how many CNPs does each (sender) QP receives. FIGS. 15A and 15B show corresponding results as an ECN arrival time table 1500 and CNP sent table 1550, respectively.

Per-port interval or per-dstIP interval. As shown in FIG. 15A, the first ECN-marked packet of each connection arrives at a relatively close time frame (within 50 μs). Then after a long time period (about 600 μs for NIC A, 200 μs for NIC B and NIC C), the second ECN-marked packet arrives. CNP sent table 1550 shows how many CNPs each (receiver) QP sends out on each testbed. Note that these NICs deliver different results. For NIC C, only QP1 sends two CNPs while QP2 and QP3 do not reply to the ECN-marked packets. However, for NICS A and B, each of the three QPs sends two CNPs. There are at least two modes to enforce CNP intervals: per-port and per-destination IP. With per-port mode, all connections share a same CNP timer. While with per-destination IP mode, only the connections with the same destination IP share a same CNP timer. Different NICs may use different modes, e.g., NIC C can enforce a CNP interval with per-port mode, so that after a CNP is generated for an ECN-marked packet at time 9 μs, the next CNP should be generated at least after 50+9=59 μs. As a result, only QP1 sends two CNPs. While NICS A and B use per-destination IP mode, the three QPs use separate timers and each can send two CNPs. While this is not necessarily a bug, it causes bias when users try to understand the NICs' behaviors.

### Technical Effect

The experiments shown above are just a few examples of how the disclosed implementations allow for users to set up and conduct experiments to analyze network stack behavior implemented hardware. As discussed previously, it is difficult for network engineers to fully evaluate the behavior of network stack that is implemented in hardware using conventional approaches. While hardware vendors provide documents that describe the specifications of a given network device, there are often certain behaviors that are not fully detailed in the documentation, or the documentation can be incomplete or even incorrect.

For software network stack behavior, it is relatively easy to use code such as a “shim layer” to configure tests of the network stack. On the other hand, it is far more difficult for network engineers to configure similar tests for hardware. From the perspective of an end user, a network adapter is a “black box” and network engineers cannot readily modify behavior of the network adapter.

By using a programmable network device as described herein to inject events into traffic and mirror the traffic for subsequent analysis, it is possible for network engineers to specify individual tests that they would like to conduct. The use of a configuration file or GUI to specify event parameters for testing enables the network engineers to have fine control over which behavior they would like to test. Thus, users are able to conduct very precise, deterministic tests of hardware network stack functionality without modifying the hardware itself.

Prior approaches for testing hardware stack behavior, such as RDMA implementations, typically involve running synthetic workloads to measure end-to-end performance in testbed and test cluster. This approach can reveal certain functional bugs, but may not accurately capture micro-behaviors like per-packet transmission time.

In addition, hardware network stacks provide high throughput and ultra-low latency. Thus, testing tools to accurately test hardware network stacks under realistic conditions should be able to do so at high speed with low extra delay. In the disclosed implementations, multiple traffic pooling servers are provided to handle full line-rate mirrored traffic. In some cases, the traffic pooling servers employ the same network adapter as the hosts being tested.

The use of a programmable network device to inject the events and mirror the traffic also allows the events to be injected with low latency. As shown above, the mirroring can be performed using a load-balancing approach that allows for full line-rate testing while injecting metadata such as sequence number, timestamp, and event type into the mirrored packets for subsequent analysis.

### Example Analysis Method

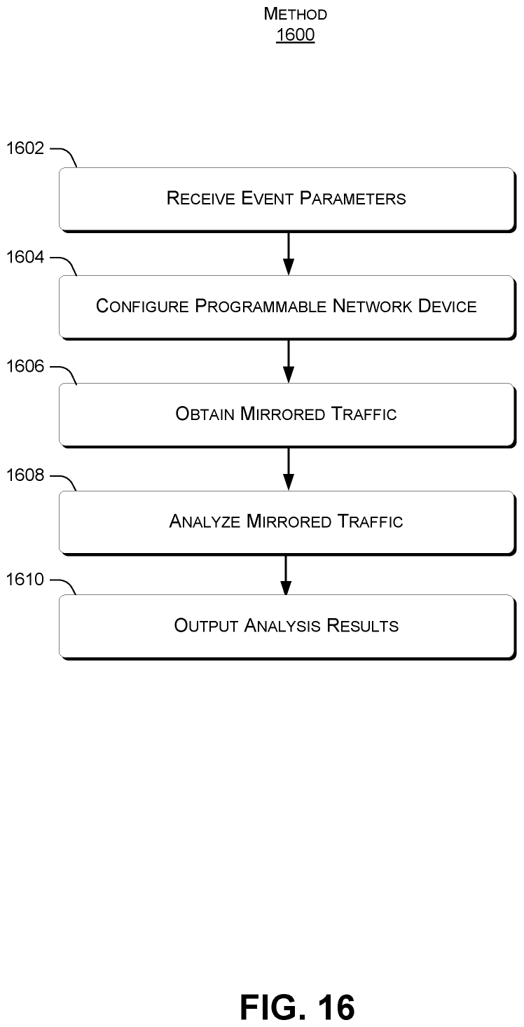

FIG. 16 illustrates an example method 1600, consistent with some implementations of the present concepts. Method 1600 can be implemented on many different types of devices, e.g., by one or more cloud servers, by a client device such as a laptop, tablet, or smartphone, or by combinations of one or more servers, client devices, etc.

Method 1600 begins at block 1602, where event parameters are received. For instance, the event parameters can be received by user input editing a configuration file or via a configuration graphical user interface. The events parameters can specify event types such as packet corruptions, packet drops, or explicit congestion notifications.

Method 1600 continues at block 1604, where a programmable network device is configured to inject events based on the event parameters. For instance, the programmable network device can be configured by sending a configuration file with the event parameters to the programmable network device. The configuration file can cause the programmable network device to inject the events into network traffic communicated between two or more hosts having network adapters that perform network stack functionality in hardware.

Method 1600 continues at block 1606, where mirrored traffic is analyzed to obtain analysis results reflecting behavior of network stack functionality. The mirrored traffic can be obtained from one or more devices, such as traffic pooling servers 150 and 160.

Method 1600 continues at block 1608, where the mirrored traffic is analyzed to obtain analysis results reflecting behavior of the network stack functionality of the network adapters. For instance, behavior such as retransmission logic, retransmission latency, timeout values, retry counts, and congestion notification behavior can be analyzed using the mirrored traffic.

Method 1600 continues at block 1610, where analysis results are output. For instance, the analysis results can be written to a file in storage or displayed via one or more graphical user interfaces as shown in any of FIGS. 9A, 9B, 10A, 10B, 11A, 11B, 12A, 12B, 13A, 13B, 14, 15A, and 15B.

Blocks 1602 and 1604 can be performed by the configuration module 114 of the orchestrator 112. Block 1606 can be performed by the data gathering module 116 of the orchestrator. Blocks 1608 and 1610 can be performed by the analysis module 118 of the orchestrator.

### Example Event Injection Method

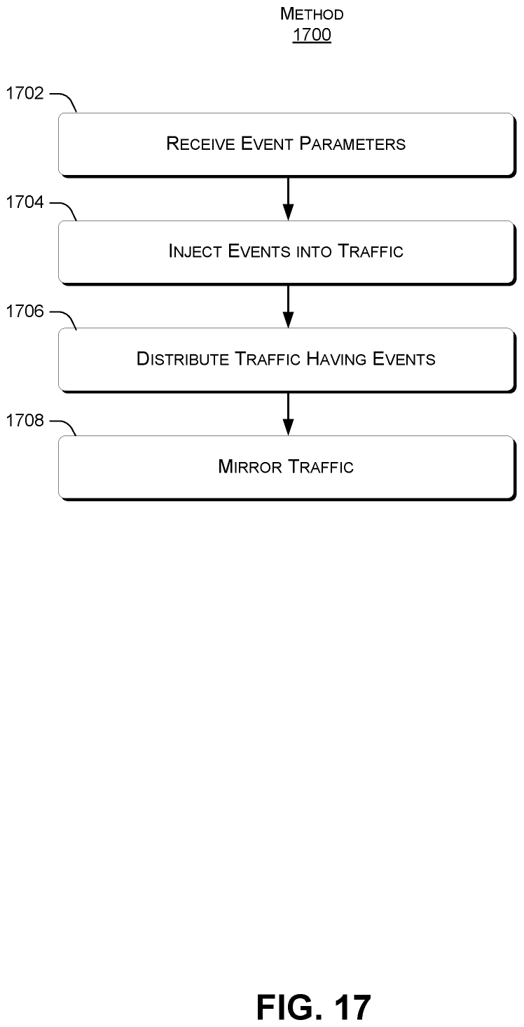

FIG. 17 illustrates an example method 1700, consistent with some implementations of the present concepts. Method 1700 can be implemented on many different types of devices, e.g., by programmable network device 140 or other types of network devices capable of distributing network traffic and injecting events into network traffic.

Method 1700 begins at block 1702, where event parameters are received. For instance, the event parameters can be received in a configuration file.

Method 1700 continues at block 1704, where events are injected into traffic communicated between two or more network adapters connected to two or more ports. For instance, the events can be injected by parsing the configuration file to extract the event parameters and configuring a map-action table according to the extracted event parameters.

Method 1700 continues at block 1706, where the traffic is distributed. For instance, the traffic with the events injected thereto can be sent out on a particular port based on a destination hardware address of a particular network adapter that is connected to that particular port.

Method 1700 continues at block 1708, where the traffic is mirrored to one or more other devices. For instance, the other devices can include one or more traffic pooling servers.

### Example Graphical Interface

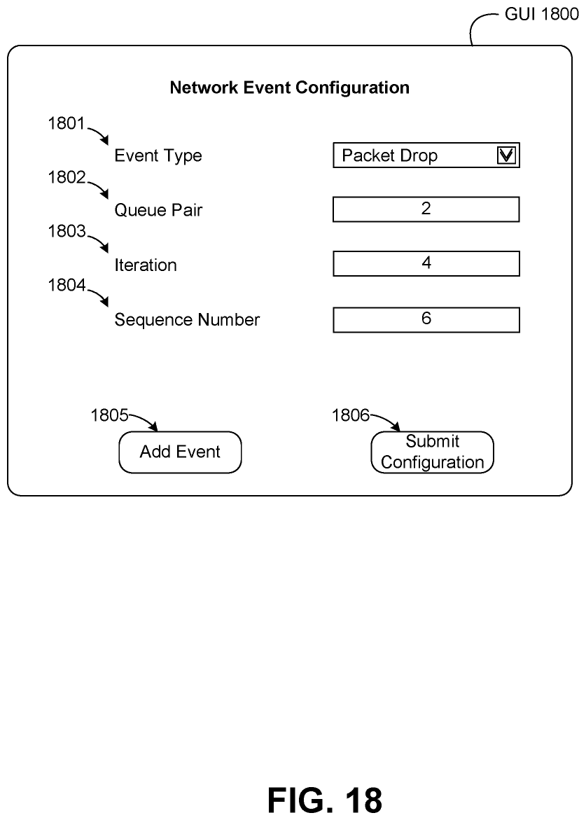

In some cases, the configuration module 114 of the orchestrator 112 can provide a graphical user interface that allows automated generation of configuration files. FIG. 18 illustrates an example configuration GUI 1800. Event type element 1801 allows a user to specify a type of event, e.g., a packet drop, ECN, etc. Queue pair element 1802 allows a user to specify which queue pair the event is inserted into. Iteration element 1803 allows the user to specify which iteration the event occurs in. Sequence number element 1804 allows the user to specify the sequence number of the packet that receives the event.

Users can add new events to a configuration file by selecting add event element 1805. When finished adding events, the user can select submit configuration element 1806, which causes the configuration module to generate a configuration file specifying the events. The configuration module can configure the programmable network device, traffic generating hosts, and traffic pooling servers for subsequent testing based on the configuration file.

### Device Implementations

As noted above with respect to FIG. 1A, system 100 includes several devices, including an orchestration server 110, a requesting server 120, a responding server 130, a programmable network device 140, a traffic pooling server 150, and a traffic pooling server 160. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 650. Without limitation, network(s) 650 can include one or more local area networks (LANs), wide area networks (WANs), the Internet, and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

Various examples are described above. Additional examples are described below. One example includes a method comprising configuring a programmable network device to inject events into network traffic communicated between two or more hosts having network adapters that perform network stack functionality in hardware, obtaining mirrored traffic provided by the programmable network device, the mirrored traffic including the injected events, analyzing the mirrored traffic to obtain analysis results, the analysis results reflecting behavior of the network stack functionality in response to the injected events, and outputting the analysis results.

Another example can include any of the above and/or below examples where the injected events comprise packet corruptions.

Another example can include any of the above and/or below examples where the injected events comprise packet drops.

Another example can include any of the above and/or below examples where the injected events comprise explicit congestion notification marks.

Another example can include any of the above and/or below examples where the method further comprises populating a configuration file with event parameters for the events and sending the configuration file to the programmable network device, the programmable network device being configured to read the configuration file and inject the events according to the event parameters.

Another example can include any of the above and/or below examples where the configuration file identifies a particular queue pair for which the programmable network device is to inject a particular event.

Another example can include any of the above and/or below examples where the configuration file identifies a particular packet sequence number of a particular packet in which to inject the particular event.

Another example can include any of the above and/or below examples where the configuration file identifies a particular event type of the particular event.

Another example can include any of the above and/or below examples where the configuration file identifies an iteration number specifying a transmission round in which the particular event is to be injected by the programmable network device.

Another example can include any of the above and/or below examples where the analysis results reflect retransmission latency.

Another example can include any of the above and/or below examples where the analysis results reflect timeout values and retry counts.

Another example can include any of the above and/or below examples where the analysis results reflect congestion notification behavior.

Another example includes a programmable network device comprising a plurality of ports, and a programmable logic circuit configured to receive event parameters of events to inject into network traffic communicated between two or more network adapters connected to two or more of the ports, inject the events into the network traffic, distribute the network traffic having the injected events between the two or more network adapters, and mirror the network traffic to one or more other devices for subsequent analysis.

Another example can include any of the above and/or below examples where the programmable logic circuit is configured to populate a match-action table to inject the events based at least on the event parameters.

Another example can include any of the above and/or below examples where the injected events include at least one of a packet corruption event, a packet drop event, or an explicit congestion notification event.

Another example can include any of the above and/or below examples where the programmable logic circuit is configured to inject the events for a particular queue pair specified by the event parameters.

Another example can include any of the above and/or below examples where the event parameters are received in a configuration file and the programmable logic circuit is configured to parse the configuration file to extract the event parameters from the configuration file.

Another example includes a system comprising a processor, and a storage medium storing instructions which, when executed by the processor, cause the system to configure a programmable network device to inject events into network traffic communicated between two or more hosts having network adapters that perform network stack functionality in hardware, obtain mirrored traffic provided by the programmable network device, the mirrored traffic including the injected events, analyze the mirrored traffic to obtain analysis results, the analysis results reflecting behavior of the network stack functionality in response to the injected events, and output the analysis results.

Another example can include any of the above and/or below examples where the outputting of the results comprises displaying one or more graphical user interfaces that convey at least one of retransmission latency, timeout values, retry counts, or congestion notification behavior.

Another example can include any of the above and/or below examples where the instructions, when executed by the processor, cause the system to display a graphical user interface having elements for specifying event parameters, receive user input directed to the elements of the graphical user interface, the user input identifying particular event parameters for particular events, and configure the programmable network device to inject the particular events according to the particular event parameters.

1. A method comprising:
configuring a programmable network device to inject events into network traffic communicated between two or more hosts having network adapters that perform network stack functionality in hardware;
obtaining mirrored traffic provided by the programmable network device, the mirrored traffic including the injected events;
analyzing the mirrored traffic to obtain analysis results, the analysis results reflecting behavior of the network stack functionality in response to the injected events; and
outputting the analysis results.

2. The method of claim 1, wherein the injected events comprise packet corruptions.

3. The method of claim 1, wherein the injected events comprise packet drops.

4. The method of claim 1, wherein the injected events comprise explicit congestion notification marks.

5. The method of claim 1, further comprising:
populating a configuration file with event parameters for the events; and
sending the configuration file to the programmable network device, the programmable network device being configured to read the configuration file and inject the events according to the event parameters.

6. The method of claim 5, wherein the configuration file identifies a particular queue pair for which the programmable network device is to inject a particular event.

7. The method of claim 6, wherein the configuration file identifies a particular packet sequence number of a particular packet in which to inject the particular event.

8. The method of claim 7, wherein the configuration file identifies a particular event type of the particular event.

9. The method of claim 8, wherein the configuration file identifies an iteration number specifying a transmission round in which the particular event is to be injected by the programmable network device.

10. The method of claim 1, wherein the analysis results reflect retransmission latency.

11. The method of claim 1, wherein the analysis results reflect timeout values and retry counts.

12. The method of claim 1, wherein the analysis results reflect congestion notification behavior.

13. A programmable network device comprising:
a plurality of ports; and
a programmable logic circuit configured to:
receive event parameters of events to inject into network traffic communicated between two or more network adapters connected to two or more of the ports;
inject the events into the network traffic;
distribute the network traffic having the injected events between the two or more network adapters; and
mirror the network traffic to one or more other devices for subsequent analysis.

14. The programmable network device of claim 13, wherein the programmable logic circuit is configured to populate a match-action table to inject the events based at least on the event parameters.

15. The programmable network device of claim 13, wherein the injected events include at least one of a packet corruption event, a packet drop event, or an explicit congestion notification event.

16. The programmable network device of claim 13, wherein the programmable logic circuit is configured to inject the events for a particular queue pair specified by the event parameters.

17. The programmable network device of claim 13, wherein the event parameters are received in a configuration file and the programmable logic circuit is configured to parse the configuration file to extract the event parameters from the configuration file.

18. A system comprising:
a processor; and
a storage medium storing instructions which, when executed by the processor, cause the system to:
configure a programmable network device to inject events into network traffic communicated between two or more hosts having network adapters that perform network stack functionality in hardware;
obtain mirrored traffic provided by the programmable network device, the mirrored traffic including the injected events;
analyze the mirrored traffic to obtain analysis results, the analysis results reflecting behavior of the network stack functionality in response to the injected events; and
output the analysis results.

19. The system of claim 18, wherein the outputting of the results comprises displaying one or more graphical user interfaces that convey at least one of retransmission latency, timeout values, retry counts, or congestion notification behavior.

20. The system of claim 18, wherein the instructions, when executed by the processor, cause the system to:
display a graphical user interface having elements for specifying event parameters;
receive user input directed to the elements of the graphical user interface, the user input identifying particular event parameters for particular events; and
configure the programmable network device to inject the particular events according to the particular event parameters.
